(19) United States
(12) Patent Application Publication
(10) Pub. No.: US 2005/0088938 A1
(43) Pub. Date: Apr. 28, 2005

(54) Method for tilt correction

(75) Inventor: Chen-Li Yen, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On IT Corporation

(21) Appl. No.: 10/969,419

(22) Filed: Oct. 20, 2004

(30) Foreign Application Priority Data
Oct. 24, 2003 (TW) 92129682

(51) Int. Cl. G11B 7/00

(52) U.S. Cl. 369/53.19

(57) ABSTRACT

The present invention discloses a method for tilt correction. A plurality of reference values for DAC are imported at the beginning and then PI/PO corresponding to each of the reference values for DAC is produced. By the usage of a specified function plot Constructed of reference values for DAC and the corresponding values of PI/PO, the minimum value of the PI/PO in the specified function plot is sorted and the reference value for DAC corresponding to the minimum value of the PI/PO stands for the optimum compensated value for tilt.

### BACKGROUND OF THE INVENTION

1. Field of the Invention

The present invention relates to a method for tilt correction, and in particular to a method for tilt correction in optical disk system.

2. Description of the Related Art

Recently, optical disks as efficient communicative storage means have been widely applied to be feasible to most electronic devices such as office facilities, computers, entertainment equipments, industrial control boxes and so on. For reading and/or writing the optical disks, a disk drive is common for the domestic device to manage the information stored or to be stored in the optical disk.

In an optical disk system, a laser beam is brought to focus through the transparent substrate, interacts with the data stored on the disk (in the form of pits, marks, magneto-optical domains, etc.) and is reflected back through the same objective lens that is used for focusing.

Typically, the disk is not perfectly flat, and any local deviations from flatness appear as a slight tilt of the front facet relative to the incoming beam.

Wherein, tilt can be divided into tangential tilt and radial tilt. The tangential tilt means the tilt projection in the tangential direction of the disk track and the radial tilt means the tilt projection in the radial direction of the disk track.

The tangential tilt and the radial tilt would lead the focused-spot spread out in tangential and radial direction of the disk track respectively. As a result of the spread out of the focused-spot, errors in reproducing are arising.

Since the focused-spot spread out in tangential direction of the disk track, the adjacent information in the same track is reproduced. Thus the tangential tilt leads the intersymbol interference. So far, the tangential tilt can be compensated by the equalizer.

However, for the spread out of the focused-spot in the radial direction of the disk track, the information in the adjacent tracks is thus reproduced during readout, which is called cross talk. The radial tilt can't be compensated by the equalizer so series errors in reproducing are arising.

The effect of this disk tilt is a degradation of the focused-spot quality and thus a drop in the carrier-to-noise ratio during readout, an increase in cross talk and intersymbol interference, and a reduction in recording sensitivity.

### SUMMARY OF THE INVENTION

Accordingly, a method of adjusting a first parameters is provided to compensate the tilt and then the information in the disk can be reproduced correctly.

To achieve the foregoing and other objects, the invention discloses a specified function plot constructed of a first parameters and a second parameters.

Moreover, the first parameters are gathered in a first sample rate when the corresponding second parameters are larger than a PI threshold.

Accordingly, the second parameters are gathered in a second sample rate when the corresponding second parameters are smaller than a PI threshold. Wherein, the first sample rate is smaller than the second rate for decreasing the complexity of calculating.

Furthermore, the minimum value of the second parameters is utilized to obtain an optimum compensated value for tilt. Wherein, a way of band setting is utilized to obtain the minimum value of the second parameters.

By the way of band setting, the point of the left boundary within the band and the point of the right boundary within the band are used to obtain the first parameters respectively. Moreover, the average value of the two first parameters obtained by the left and right boundary is calculated for approaching the minimum value of the second parameters.

As a result, the optimum compensated value for tilt in this invention is the average value of the two first parameters and is retained in the EEPROM.

Moreover, the exhaustive search can also be utilized to search for the extreme value of the function plot.

### BRIEF DESCRIPTION OF THE DRAWINGS

The present invention can be more fully understood by reading the subsequent detailed description and examples with references made to the accompanying drawings, wherein:

FIG. 1 illustrates a diagram showing the relative value of PI/PO to the reference values for DAC.

FIG. 2 illustrates a way of band setting utilized to obtain the minimum value of the PI/PO.

### DETAILED DESCRIPTION OF THE INVENTION

As summarized above, the present invention is directed to a method for tilt correction. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the optical pick up head is controlled by a predetermined voltage and the predetermined voltage is used to produce a compensated value for tilt. The predetermined voltage is applied to the optical pick up head for compensating the tilt.

Moreover, the predetermined voltage is derived by a plurality of the first parameters and the corresponding value of PI/PO (Parity of Inner Code/Parity of Outer Code). The first parameters are the reference values for DAC (Digital to Analog converter). After inputting the first parameters to DAC, the voltages applied to the optical pick up head is then derived. Wherein, the value of PI/PO is a target for the quality of the reproduced signal.

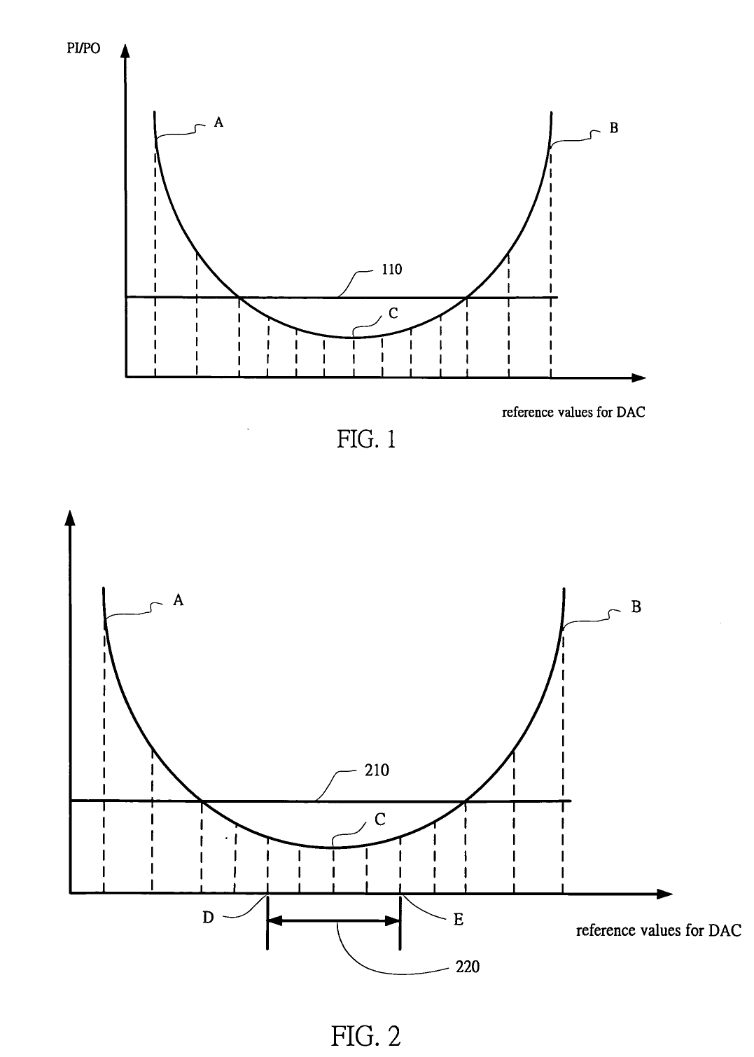

Please refer to FIG. 1, a diagram showing the relative value of PI/PO to the reference values for DAC is illustrated. Wherein, the first parameters of the horizontal axis are the reference values for DAC which are converted to the analog voltages for controlling the optical pick up head to compensate the tilt. The second parameters of the vertical axis are the corresponding value of PI/PO which is a target for the quality of the reproduced signal.

Referred to FIG. 1, each of the first parameters indicates a predetermined voltage applied to the optical pick up head for compensating the tilt. Each of the first parameters can also be derived in accordance with the PI threshold 110.

Referred to FIG. 1, one part of the first parameters can be derived by a first sample rate when the corresponding values of PI/PO are larger than PI threshold 110. Accordingly, the other part of the first parameters can be derived by a second sample rate when the corresponding values of PI/PO are smaller than PI threshold 110. Wherein, the first sample rate is smaller than the second sample rate. As a result, a parabolic curve as illustrated in FIG. 1 can be derived by each of the first parameters and the corresponding values of PI/PO in the above first sample rate and second sample rate.

The larger of the values of PI/PO means the worse of the quality of the reproduced signal. When the values of PI/PO are large as the point A and the point B in the FIG. 1, it means that the true tilt can not be compensated by the compensated value for tilt. Accordingly, The smaller of the values of PI/PO means the better of the quality of the reproduced signal. When the values of PI/PO are small as the point C in the FIG. 1, it means that the true tilt can be compensated by the compensated value for tilt. As a result, the extreme value of the PI/PO can be utilized to obtain the optimum compensated value for tilt in this invention.

As illustrated in FIG. 1, the minimum value of the PI/PO is utilized to obtain the optimum compensated value for tilt. When the parabolic curve as illustrated in FIG. 1 is derived by each of the first parameters and the corresponding values of PI/PO in the above first sample rate and second sample rate, a way of band setting is utilized to obtain the minimum value of the PI/PO. Please refer to FIG. 2, a way of band setting utilized to obtain the minimum value of the PI/PO is illustrated.

As illustrated in FIG. 2, a band setting 220 is utilized. The point of the left boundary as the point D in FIG. 2 and the point of the right boundary as the point E in FIG. 2 are used to obtain the reference values for DAC respectively. The average value of the reference value for DAC of point D and that of point E is calculated for approaching the reference value for DAC of point C. Moreover, the reference value for DAC of point C corresponds to the minimum value of PI/PO. As a result, the optimum compensated value for tilt in this invention is the reference value for DAC of point C and the reference value for DAC of point C is retained in the EEPROM.

Moreover, the exhaustive search can also be utilized to obtain the extreme value of the parabolic curve. The corresponding value of the PI/PO of each reference value for DAC would be compared to each other. Each time the comparing executed, the large value of the PI/PO would be eliminated and the smaller value of the PI/PO would be survived for the next comparing. As a result, the minimum value of PI/PO and the corresponding reference value for DAC are derived by the exhaustive search and the corresponding reference value for DAC is retained in the EEPROM.

In this preferred embodiment of the present invention, the parabolic curve is derived by each of the first parameters and the corresponding values of PI/PO. The parabolic curve is utilized to obtain the minimum value of PI/PO and the optimum compensated value for tilt is then obtained.

Furthermore, a parabolic curve can be derived by each of the first parameters and the corresponding values of PI/PO in a first sample rate and a second sample rate to decrease the complexity of the calculation.

Particularly, a way of band setting is provided to obtain the minimum value of PI/PO efficiently in this invention.

Moreover, a method of adjusting the first parameters is provided to compensate the tilt and then the information in the disk can be reproduced correctly.

While the present invention has been particularly shown and described with reference to a preferred embodiment, it will be understood by those skilled in the art that various changes in form and detail may be without departing from the spirit and scope of the present invention.

1. A method for tilt correction; comprising the steps of:
inputting a plurality of first parameters to obtain a plurality of second parameters;
utilizing the first parameters and the second parameters to form a specified function plot;
setting a band in the specified function plot; and
searching for a predetermined value from the first parameters within the band.

2. A method for tilt correction according to claim 1, wherein the first parameters are a plurality of reference values for Digital to Analog Converter.

3. A method for tilt correction according to claim 1, wherein the second parameters are a plurality of values of Parity of Inner Code/Parity of Outer Code.

4. A method for tilt correction according to claim 1, wherein the specified function plot is a parabolic curve.

5. A method for tilt correction according to claim 4, wherein the predetermined value is a first parameter corresponding to a minimum value of the parabolic curve.

6. A method for tilt correction according to claim 5, wherein the band is utilized to obtain the minimum value of the parabolic curve.

7. A method for tilt correction according to claim 5, wherein the minimum value of the parabolic curve is obtained by an average value.

8. A method for tilt correction according to claim 7, wherein the average value is obtained by averaging a first parameter at a left boundary of the band and a first parameter at a right boundary of the band.

9. A method for tilt correction according to claim 1, wherein the predetermined value is an optimum compensated value for tilt.

10. A method for tilt correction according to claim 1, wherein the predetermined value is retained in an EEPROM.

11. A method for tilt correction according to claim 1, wherein the first parameters are sampled in a first sample rate and a second sample rate.

12. A method for tilt correction according to claim 11, wherein the first sample rate is used when the corresponding second parameters are larger than a value of PI threshold.

13. A method for tilt correction according to claim 12, wherein the second sample rate is used when the corresponding second parameters are smaller than the value of PI threshold.

14. A method for tilt correction according to claim 11, wherein the first sample rate is smaller than the second sample rate.

15. A method for tilt correction; comprising the steps of:
inputting a plurality of first parameters to obtain a plurality of second parameters;
utilizing the first parameters and the second parameters to form a specified function plot; and
searching for a predetermined value from the first parameters.

16. A method for tilt correction according to claim 15, wherein the first parameters are a plurality of reference values for Digital to Analog Converter.

17. A method for tilt correction according to claim 15, wherein the second parameters are a plurality of values of Parity of Inner Code/Parity of Outer Code.

18. A method for tilt correction according to claim 15, further comprising a step of setting a band in the specified function plot.

19. A method for tilt correction according to claim 15, wherein the predetermined value is obtained by an average value.

20. A method for tilt correction according to claim 19, wherein the average value is obtained by averaging a first parameter at a left boundary of a band and a first parameter at a right boundary of a band.
